(19) United States
(12) Patent Application Publication
(10) Pub. No.: US 2003/0162081 A1
(43) Pub. Date: Aug. 28, 2003

(54) Dimensionally stable gas diffusion electrode

(76) Inventors: Fritz Gestermann, Leverkusen (DE); Hans-Dieter Pinter, Wermelskirchen (DE); Alfred Soppe, Issum (DE); Peter Weuta, Leverkusen (DE)

Correspondence Address: BAYER POLYMERS LLC, 100 BAYER ROAD, PITTSBURGH, PA, 15205, US

(21) Appl. No.: 10/296,359

(22) PCT Filed: May 21, 2001
(86) PCT No.: PCT/EP01/05780

(30) Foreign Application Priority Data
Jun. 2, 2000 (DE) 100 27 339.4

(51) Int. Cl. H01M 4/94; H01M 4/96; H01M 4/88

(52) U.S. Cl. 429/42; 429/44; 502/101

(57) ABSTRACT

A dimensionally stable gas diffusion electrode and a method for the fabrication thereof are described. The electrode comprises at least an electroconductive catalyst support material to accommodate a catalyst material-containing coating composition and an electrical connection, the catalyst support material (4; 11) being a fabric, bonded fibre web, foam, sintered metal body or felt of electroconductive material, an expanded-metal plate or a metal plate provided with a multiplicity of perforations (2, 8), on top of which plate the catalyst material-containing coating composition (5) is applied, the material, if its inherent stiffness is inadequate, being permanently joined mechanically and electroconductively to a gas-permeable, alkali-resistant metallic baseplate (1; 7), especially comprising nickel or its alloys.

The invention relates to a dimensionally stable gas diffusion electrode comprising at least an electroconductive catalyst support material to accommodate the catalyst material-containing coating composition and an electrical connection, and a method of fabricating the electrode. The catalyst support material is a fabric, bonded fibre web, sintered metal body, foam or felt of electroconductive material, an expanded-metal plate or a metal plate provided with a multiplicity of perforations, on top of which structures the catalyst material-containing coating composition is applied and which plate is permanently joined mechanically and electroconductively to a gas-permeable metallic baseplate, especially made of nickel or a nickel/silver alloy or an alkali-resistant metal alloy. If the catalyst support material has adequate inherent stiffness, the use of a baseplate can be dispensed with and the catalyst support material provided with catalyst material-containing coating composition can be incorporated directly in an electrochemical reaction apparatus.

Gas diffusion electrodes are employed in various arrangements in electrochemical processes. In fuel cells comprising a solid electrolyte polymer membrane, for example, the gas diffusion electrodes, in the form of a hydrogen-consuming anode and an oxygen-consuming cathode (OCC) are placed directly on top of the membrane. In the case of the HCl electrolysis using an oxygen-consuming cathode, the latter likewise lies directly on the membrane.

In the case of the NACl electrolysis using OCC e.g., on the other hand, it proved advantageous to operate with the OCC being separated from the membrane by an alkali-perfused gap having a width of a few mm. With a customary industrial-style overall height of more than one metre, the OCC can be operated advantageously with pressure compensation according to the gas pocket principle, as described in U.S. Pat. No. 5,693,202. With a customary height of the gas pockets of 15-35 cm, the electrode is free standing between caustic soda solution and oxygen. As an altitude-dependent differential pressure, limited, but still present, applies across the OCC which, like a membrane, is of relatively resilient design, the OCC has to be braced by means of spacers to prevent it from bulging towards the membrane or in the other direction towards the gas pocket. Uncontrolled bulging of the OCC towards the membrane results in a reduction of the catholyte gap and possibly even in contact between OCC and membrane. This leads to a disruption of the alkali flow in conjunction with uneven concentration distribution and possible damage to the membrane. Any oxygen gas bubbles passing through the OCC cannot move away unimpededly and will collect upstream of locations where the electrolyte gap is markedly reduced. This leads to masking of membrane and electrode and consequently to an increase in the local current density in the remaining electrode area. The effects described result in an increased k factor, i.e. an excessive increase in the operating voltage as a function of the increase in the current density and consequently in an excessive specific energy consumption.

The spacer in particular, between electrode and membrane, has caused problems again and again. For example, local contact sites in conjunction with structural movement in the electrolytic cell have occasionally resulted in abraded patches on the membrane which, at extended operating times, give rise to leaks. Similarly, the OCC, too, suffered from pressure marks which could quite possibly cause damage, given the aimed-for operating times of several years. Moreover, the spacers mask both electrode areas and membrane areas, likewise resulting in high current densities and consequently high voltages and a high specific energy consumption. A solution was therefore sought which would allow such spacers to be dispensed with.

Many attempts to apply the nonrigid OCC to a rigid support failed in the past because of the problem that the electrode first had to be sintered and pressure-moulded in order to attain the necessary density in conjunction with controlled porosity, and that the fluoropolymer-containing electrode structure then had to be bonded metallically, i.e. by means of welding or soldering, to the rigid support. In practice, such a bond is not durable and, moreover, because of the fluorides released, is very corrosion-prone. It is an object of the invention to provide a stable gas diffusion electrode and a method of fabricating it, which does not have the said drawbacks.

The solution is to apply the catalyst material-containing coating composition by means of the wet- or dry-calendaring method, known in principle, to a metallic, single- or multilayer supporting structure of the configuration described hereinafter.

The invention relates to a dimensionally stable gas diffusion electrode comprising at least an electroconductive catalyst support material to accommodate a catalyst material-containing coating composition, especially comprising mixtures of finely dispersed silver powder or finely dispersed silver oxide powder or mixtures of silver powder and silver oxide powder and Teflon powder or of mixtures of finely dispersed silver powder or silver oxide powder or mixtures of silver powder and silver oxide powder, carbon powder and Teflon powder, and further comprising an electrical connection, characterized in that the catalyst support material is a fabric, bonded fibre web, sintered metal body, foam or felt of electroconductive material, an expanded-metal plate or a metal plate provided with a multiplicity of perforations on top of which plate the catalyst material-containing coating composition is applied, the material having adequate flexural strength so that additional stiffening by using an additional baseplate can be dispensed with, or the said material being permanently joined mechanically and electroconductively to a gas-permeable, stiff metallic baseplate or a stiff fabric or expanded metal, especially comprising nickel or its alloys or alkali-resistant metal alloys.

The open structure serving as a catalyst support material consists, in particular, of a fine wire cloth or a suitable expanded-metal foil, filter screen, felt, foam or sintered material, into which the catalyst material-containing coating composition interlocks when it is rolled in. In one embodiment, this open structure is metallically bonded, e.g. by sinter-bonding, to the quite open but more compact and stiff substructure even before the catalyst material-containing coating composition is pressed in or rolled in.

The function of this substructure is that of an abutment while the catalyst material-containing coating composition is pressed in, quite possibly spreading in the process into structure-related interstices between the two layers, resulting in even more effective interlocking.

The metal for the baseplate is preferably selected from the series consisting of nickel or an alkali-resistant nickel alloy, especially nickel with silver, or silver-coated nickel, or an alkali-resistant metal alloy.

Alternatively, in special cases, the baseplate used can be a stiff foam or a stiff sintered structure or a perforated plate or a slotted plate of a material from the series nickel, alkali-resistant nickel alloy or alkali-resistant metal alloy, especially nickel with silver or silver-coated nickel. The catalyst material-containing coating composition, rolled out into a sheet in a previous operation, in this case is directly rolled into the base structure which at the same time has the function of a catalyst support material. No additional catalyst support material is used, therefore.

The catalyst support material preferably comprises carbon, metal, especially nickel or nickel alloys, or an alkali-resistant metal alloy.

To allow reaction gas to be passed through more effectively, the baseplate preferably has a multiplicity of perforations, especially slots or drilled holes.

The perforations preferably have a width of at most 2 mm, especially at most 1.5 mm. The slots can have a length of up to 30 mm.

If a foam or a porous sintered structure is used, the pores have a mean diameter of preferably at most 2 mm. The structure is distinguished by high stiffness and flexural strength.

In a particular embodiment of the gas diffusion electrode, the catalyst support material used is a foam or sintered metal body and an edge designated for bonding the electrode to an electrochemical reaction apparatus is compressed to achieve the necessary gas-/liquid-tightness.

A preferred variation of the gas diffusion electrode is characterized in that the baseplate has an imperforate circumferential edge of at least 5 mm which serves to fasten the electrode, especially by welding or soldering or by means of screws or rivets or clamps or by the use of an electroconductive adhesive to the edge of the gas pocket to be bonded to the electrode.

A selected form of the gas diffusion electrode is characterized in that the catalyst support material and the catalyst material-containing coating composition are bonded together by dry calendaring.

According to the design of a preferred variation of the gas diffusion electrode, the catalyst support material and the catalyst material-containing coating composition are applied to the catalyst support material by the coating composition, which contains water and possibly organic solvent (e.g. alcohol) being poured on or wet-rolled, followed by bonding by means of drying, sintering and possible compaction.

For the purpose of an improved uniform gas supply to the gas diffusion electrode in a special design there is provided, between the baseplate and the catalyst support material an additional electroconductive gas distribution fabric which, in particular, comprises carbon or metal, especialy nickel, or an alkali-resistant nickel alloy, especially nickel with silver, or silver-coated nickel or an alkali-resistant metal alloy.

In a special embodiment of this gas diffusion electrode, the baseplate has an extensive recess to accommodate the gas distribution fabric.

It was found that particularly good utility is ensured by a design of the gas diffusion electrode in which the layer of catalyst support material and catalyst material-containing coating composition is bonded circumferentially and gas tightly in the edge region within the electrode to the edge of the baseplate.

The gas tight join can be effected, for example, by sealing or by flat-rolling, optionally ultrasonically enhanced.

If a foam or a porous sintered structure is used as the catalyst support material or the baseplate, after coating of the structure with catalyst material-containing coating composition, a circumferential edge zone is forcibly pressure bonded to achieve a gas tight edge region.

The gas diffusion electrode preferably has an edge without perforations or an edge sealed by a porous base structure being pressure bonded, and at the said imperforate edge is joined gas tightly and electroconductively to an electrochemical reaction apparatus by means of welding, soldering, screwing, riveting, clamping or the use of alkali-resistant, electroconductive adhesive.

If the said bonding of the gas diffusion electrode to the electrochemical reaction apparatus is effected by means of welding or soldering, the imperforate edge preferably is silver-free.

If, on the other hand, the said joining of the gas diffusion electrode to the electrochemical reaction apparatus is effected by means of screwing, riveting, clamping or the use of electroconductive adhesive, the imperforate edge preferably contains silver.

In the case of a gas diffusion electrode being integrated into the electrochemical reaction apparatus by screwing, riveting or clamping, the edge zone of the baseplate is advantageously sealed against the mounting face of the electrochemical apparatus by means of a resilient lining.

The invention also relates to a method of fabricating a gas diffusion electrode according to the invention by sinter-bonding the catalyst support material to a baseplate which is provided with a multiplicity of perforations, and applying the powdered or fibrous catalyst material-containing coating composition, which may have been rolled out into a sheet in a previous operation, by dry calendering at a pressure of at least 3·10⁵ pascal.

The invention further relates to an alternative method of fabricating a gas diffusion electrode by applying a low-viscosity to paste-like mixture of catalyst with water and possibly an organic solvent, for example alcohol, having a solvent fraction of between 0 and 100% and a solids content of between 5 and 95%, the mixture being applied by rolling, spatulation or pouring, followed by drying and sintering at a higher temperature, especially of at least 100° C. and of at most 400° C., under a protective gas, especially nitrogen, carbon dioxide, noble gas or a reducing medium, particularly preferably argon, neon, krypton, butane, and possible further rolling of the sintered composite at a pressure of at least 3·10⁵ pascal.

Preferably, sinter-bonding of the catalyst support material to the baseplate is followed by the surface of the catalyst support material being provided with a silver layer, especially by electrode deposition or electroless deposition.

In a particular version of the method, application of the catalyst support material to the baseplate is preceded by a gas distribution fabric being applied and being sinter-bonded to the baseplate.

A particularly preferred method is characterized in that sinter-bonding of catalyst support material, gas distributor and baseplate is effected simultaneously.

To avoid unacceptable deformation of the superstructure into the substructure during the rolling operation, the perforation pitches of the two layers should be suitably tailored with respect to one another. In addition, adequate drainage of condensate or caustic soda solution must be ensured to prevent the gas transport channels from being blocked.

During operation of the gas diffusion electrode according to the invention as an oxygen-consuming cathode (OCC), said structure supplies the catalytically active layer with oxygen via its openings and forms the stiff base which renders this gas diffusion electrode dimensionally stable and stable against deformation..

The simultaneous use of a superstructure and a substructure is not absolutely necessary, however; direct coating of the baseplate is also conceivable.

The application of a catalyst composition in the form of a low-viscosity composition or a paste via the wet-rolling technique by means of pouring or spatulating it on, followed by drying, sintering and possible compaction by rolling is a further variation of the method.

To fit the electrode into a gas pocket structure by means of screwed, riveted, clamping, soldered, welded or adhesive joints, the slightly projecting substructure edge can preferably be utilized, which is preferably located below the catalyst support material structure and can be suitably protected against the fluoropolymers while the catalyst material-containing coating composition is being applied by calendaring. It is particularly advantageous for this part to be excluded while the openings in the form of holes, slots etc. are being punched, i.e. for it to remain solid, thereby making it possible to prevent lateral escape of the oxygen. Escape of the oxygen from the boundary region between the two layers can be avoided by suitable flat-rolling of a narrow, catalyst-filled edge strip of the upper layer onto the substructure, which should no longer be slotted at this point or else should be metallically covered in some other way and be impervious. Good utility for flat-rolling the edge strip is ensured, for example, by the use of an ultrasonically excited, rotating roller head. The transmission of the pressure/vibration forces results in complete filling of the gaps with catalyst material-containing coating composition.

If a foam or an open-pored sintered structure is used as the base body, the object of preventing oxygen from escaping in the edge region is pursued by forcibly compressing the porous structure in a circumferential edge region. The forcible compaction results in the formation of a gas tight structure.

The way in which the catalyst is applied, especially via the dry calendering technique, but also via the wet calendering technique and the spatulation technique, allows spent catalyst layers to be removed by being blown out or jetted out vigorously, thus permitting the metallic support structure to be recoated.

Depending on the way the gas diffusion electrode, e.g. as an OCC, is inserted into a gas pocket or attached to the gas pocket, it is quite conceivable for this double structure to be reused a number of times, thus allowing considerable cost savings. The catalyst, on the other hand, can be recovered chemically and/or electrochemically by simple means from the extracted composition, thus allowing the recycling precept to be applied even in this respect.

The invention further relates to an electrochemical gas diffusion cell which includes a gas diffusion electrode according to the invention as described hereinabove.

In such an arrangement, the electrochemical gas diffusion cell can be arranged with permanently installed gas pockets or alternatively with removable gas pockets.

The invention is explained below in more detail by way of example with reference to the figures, in which

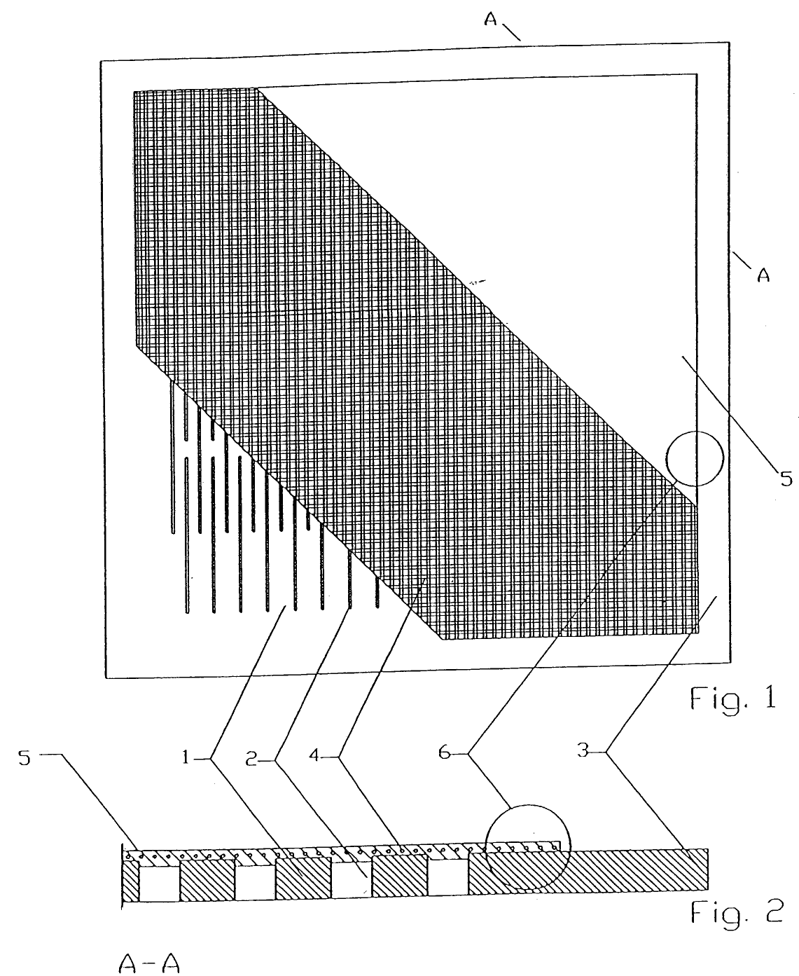

FIG. 1 shows a schematic of the design of a gas diffusion electrode according to the invention,

FIG. 2 shows the cross section through the electrode according to FIG. 1 on A-A

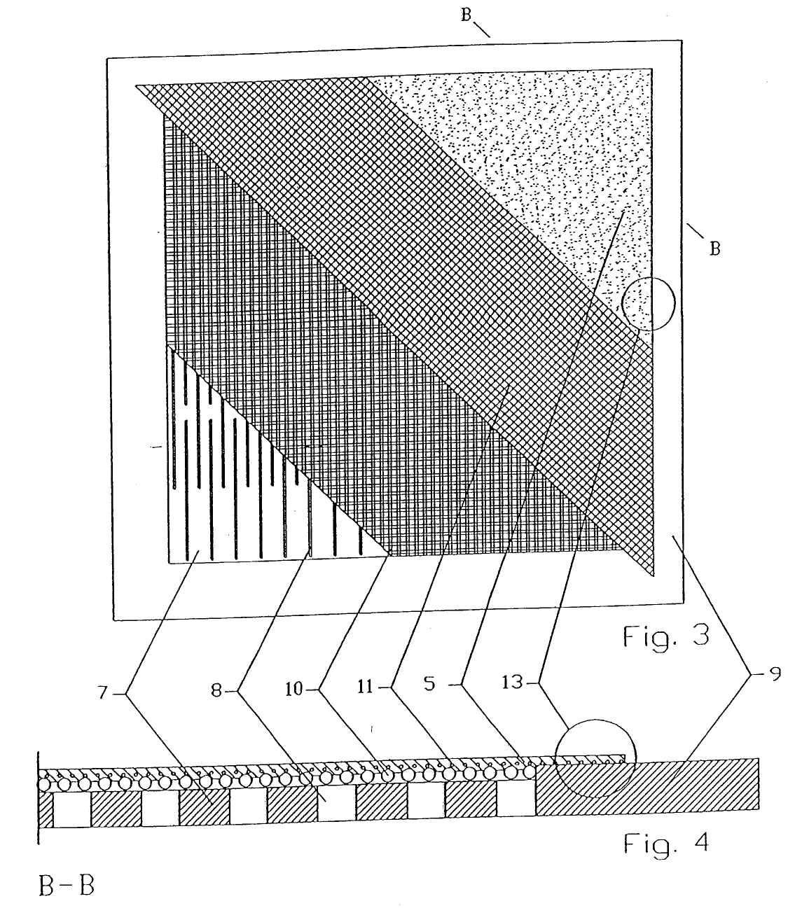

FIG. 3 shows a schematic of a variation of the electrode according to FIG. 1 with an additional gas diffusion fabric 10,

FIG. 4 shows the cross section through the electrode according to FIG. 3 on B-B

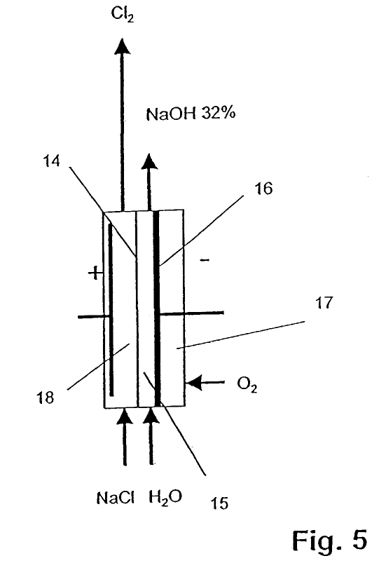

FIG. 5 shows a schematic of an electrolytic cell comprising the gas diffusion electrode

### EXAMPLES

Percentages refer to percentages by weight, unless stated otherwise.

### Example 1

(FIG. 1+2)

Fabrication of a dimensionally stable gas diffusion electrode of two-layer design: The baseplate (1) consists of nickel plate having a thickness of 1.5 mm with perforations (slots) (2) which are 1.5 mm wide and 15 mm long (from Fiedler/D). The distribution of the slots is chosen such that they are spaced 5 mm apart in the longitudinal direction and 2 mm apart in the transverse direction. The juxtaposed longitudinal rows of these slots are offset against one another by half a period, so that the slot comes to lie next to space.

This base structure has an unslotted edge (3). Acting as the supporting structure for the activation is a nickel wire cloth (4) having a wire diameter of 0.14 mm and a mesh size of 0.5 mm (from Haver & Boecker/D). The wire mesh edge is flush with the edge zone. This arrangement is sinter-bonded at temperatures of between 800-1200° C.; a continuous structure is obtained.

The side which carries the wire is electro-silvered. In order to apply the activation, the unslotted edge zone (3) is masked by means of a suitable material such as e.g. wax, paint, adhesive tape or the like. The complete electrode structure is then covered with a catalyst material-containing coating composition (5) which beforehand has been rolled out into a sheet and which consists of 85% carbon black (Vulcan XC-72, 10% Ag), 15% HOSTAFLON TF 2053 (PTFE) with a coverage of 500 g/m², this being bonded to the wire cloth (4) by being rolled in, pressure bonded or the like. After the layer masking the edge region has been removed, the edge region (6), in order to achieve adequate gas tightness, is rolled flat, an ultrasonic welder with a seam welding head (from Stapla/D) being used—the electrode is now ready for installation. The integration into the electrochemical reaction apparatus is effected e.g. by welding, soldering, screwing, clamping, riveting or the use of electroconductive adhesive or the like in the solid edge zone (3).

If the gas diffusion electrode and the electrochemical reaction apparatus are joined together by means of clamping, riveting or screwing techniques, a resilient seal is placed between the gas diffusion electrode and the bearing face of the electrochemical reaction apparatus, to prevent mixing of gas phase and liquid phase.

### Example 2

Fabrication of a dimensionally stable gas diffusion electrode of two-layer design: The design is similar to that of Example 1, except that a different application technique is used for the catalyst material-containing coating composition and the application of an additional, noncatalyzed gas diffusion layer:

The side which carries the wire is silvered electrolessly. In order to apply the activation and the gas diffusion layer, the unslotted edge zone is masked on both sides by means of a suitable material such as e.g. wax, paint, adhesive tape or the like. The electrode structure is then covered on that side which does not carry the wire, with a gas diffusion layer which beforehand has been rolled out into a sheet and which consists of 70% carbon black (Vulcan XC-72, noncatalyzed), 30% HOSTAFLON TF 2053 (PTFE) with a coverage of 750 g/m², this being bonded to the slotted-plate structure by being rolled in, pressure bonded or the like.

To apply the catalyst layer, the wire-carrying side of the electrode structure is spread (“spatulation”) with a mixture which beforehand was compounded to produce a paste-like composition and consists of 70% carbon black (Vulcan XC-72, 10% Ag/PTFE mixture (85%/15%)) and 30% isopropanol, is dried at 65° C. and, to achieve adequate gas tightness, is compacted by rolling. To consolidate the electrode, this is followed by an annealing step at 250° C./1 h. The integration of the electrode into the electrochemical reaction apparatus is effected as in Example 1.

### Example 3

Fabrication of a dimensionally stable gas diffusion electrode of two-layer design: The design is similar to that of Example 1, except that a different support material is used to accommodate the catalyst: an expanded-metal foil of the type 5-Ni-5-050 pulled (thickness of the starting material: 0.127 mm, strand width: 0.127 mm, LWD: 1.27 mm, from DELKER/USA) is used. The use of expanded metal results in particularly firm interlocking between catalyst material-containing coating composition and catalyst support material.

### Example 4

(FIG. 3+4)

Fabrication of a dimensionally stable gas diffusion electrode of three-layer design: The baseplate of the electrode consists of slotted plate (7) having a thickness of 2 mm with perforations (slots) (8) which are 1.5 mm wide and 25 mm long (from Fiedler/D). The distribution of the slots is chosen such that they are spaced 5 mm apart in the longitudinal direction and 2 mm apart in the transverse direction. The juxtaposed longitudinal rows of these slots are offset against one another by half a period, so that the slot comes to lie next to space.

This base structure has an unslotted edge (9) which need not be located at the same height as the slotted bearing surface—the use of an edge located higher up proved advantageous for sealing purposes. Acting as a gas distributor is an inserted wire cloth (10) having a wire diameter of 0.5 mm and a mesh size of 0.8 mm (from Haver & Boecker/D). Applied to this structure is a fine nickel wire mesh having a wire diameter of 0.14 mm and a mesh size of 0.5 mm (from Haver & Boecker/D) (11), which, in the case sketched in FIG. 3, is flush with the edge zone.

The use of a further layer, compared with Examples 1 to 3, serves to improve the gas and liquid transport and additional interlocking of the catalyst composition.

This arrangement is sinter-bonded at temperatures of between 800-1200° C.; a continuous structure is obtained. The side which carries the wire is silvered electrolessly.

In order to apply the activation, the unslotted edge zone (9) located higher up is masked by means of a suitable material such as e.g. wax, paint, adhesive tape or the like. The complete electrode structure is then covered with a catalyst material-containing coating composition (5) which beforehand has been rolled out into a sheet and which consists of 85% carbon black (Vulcan XC-72, 10% Ag), 15% HOSTAFLON TF 2053 (PTFE) with a coverage of 500 g/m², this being bonded to the fine wire cloth (11) by being rolled in, pressure bonded or the like. After the layer masking the edge region has been removed, the edge region (13), in order to achieve adequate gas tightness, is rolled flat, an ultrasonic welder (from Stapla/D) being used; the electrode is now ready for installation. The integration into the electrochemical reaction apparatus is effected e.g. by welding, soldering, screwing, clamping, riveting or the use of electroconductive adhesive or the like in the solid edge zone (9).

If the edge (13) of the gas diffusion electrode and the electrochemical reaction apparatus are joined together by means of clamping, riveting or screwing techniques, a resilient seal is placed between the gas diffusion electrode and the bearing face of the electrochemical reaction apparatus, to prevent mixing of gas phase and liquid phase.

### Example 5

Fabrication of a dimensionally stable gas diffusion electrode of three-layer design: The design is similar to that of Example 4, except that a different support material is used for the catalyst: an expanded-metal foil of the type 5-Ni-5-050 pulled (thickness of the starting material: 0.127 mm, strand width: 0.127 mm, LWD: 1.27 mm, from DELKER/USA is used. The use of expanded metal results in particularly firm interlocking between catalyst support material and catalyst material-containing coating composition.

### Example 6

Fabrication of a dimensionally stable gas diffusion electrode of three-layer design: The design is similar to that of Example 4, except that a different support material is used for the catalyst: a thin slotted sheet having an aperture diameter of 0.3 mm and a triangular pitch of 0.6 mm is used (from Fiedler/D).

### Example 7

Fabrication of a dimensionally stable gas diffusion electrode of three-layer design: The design is similar to that of Example 4, except that a different catalyst support material and application technique is used for the catalyst material-containing coating composition: an opaque, sinter-bonded nickel felt having a thickness of 0.3 mm (from Nitech/F) is used as the catalyst support material. This absorbent structure is spread with a pourable mixture of 36% carbon black (Vulcan XC-72, 10% Ag), 64% HOSTAFLON TF 5033 suspension (10% PTFE) with a coverage of 250 g/m², is dried at 95° C. and, to achieve adequate gas tightness, is compacted by rolling. To consolidate the electrode, this is followed by an annealing step at 250° C./1 h.

Integration of the electrode into the electrochemical reaction apparatus takes place as described in Example 4.

### Example 8

Fabrication of a dimensionally stable gas diffusion electrode of single-layer design: The baseplate consists of nickel foam having a thickness of 5 mm (from Dunlop/USA). The mean pore diameter is 1 mm, the void volume is 80%.

This base structure, prior to the coating operation being complete, has a nonporous edge; a supporting structure is not used.

The side which is scheduled for subsequent coating is electro-silvered. In order to apply the activation, the edge zone is masked by means of a suitable material such as e.g. wax, paint, adhesive tape or the like. The complete electrode structure is then covered with a catalyst material-containing coating composition which beforehand has been rolled out into a sheet and which consists of 85% carbon black (Vulcan XC-72, 10% Ag), 15% HOSTAFLON TF 2053 (PTFE) with a coverage of 500 g/m², this being bonded to the foam structure by being rolled in, pressure bonded or the like. After the layer masking the edge region has been removed, the edge region, in order to achieve adequate gas tightness, is pressed to a thickness of 1 mm—the electrode is now ready for installation. The integration into the electrochemical reaction apparatus is effected e.g. by welding, soldering, screwing, clamping, riveting or the use of electroconductive adhesive or the like in the solid edge zone.

If the gas diffusion electrode and the electrochemical reaction apparatus are joined together by means of clamping, riveting or screwing techniques, a resilient seal is placed between the edge of the gas diffusion electrode and the bearing face of the electrochemical reaction apparatus, to prevent mixing of gas phase and liquid phase.

### Example 9

Fabrication of a dimensionally stable gas diffusion electrode of single-layer design: The baseplate consists of nickel plate having a thickness of 1.5 mm with slots which are 1.5 mm wide and 15 mm long (from Fiedler/D). The distribution of the slots is chosen such that they are spaced 5 mm apart in the longitudinal direction and 2 mm apart in the transverse direction. The juxtaposed longitudinal rows of these slots are offset against one another by half a period, so that the slot comes to lie next to space.

This base structure has an unslotted edge; a supporting structure is not used. The side which is scheduled for subsequent coating is electro-silvered. In order to apply the activation, the unslotted edge zone is masked by means of a suitable material such as e.g. wax, paint, adhesive tape or the like. The complete electrode structure is then covered with a catalyst material-containing coating composition which beforehand has been rolled out into a sheet and which consists of 85% carbon black (Vulcan XC-72, 10% Ag), 15% HOSTAFLON TF 2053 (PTFE) with a coverage of 500 g/m², this being bonded to the slotted plate by being rolled in, pressure bonded or the like. After the layer masking the edge region has been removed, the electrode is ready for fitting. The integration into the electrochemical reaction apparatus is effected e.g. by welding, soldering, screwing, clamping, riveting or the use of electroconductive adhesive or the like in the solid edge zone.

If the gas diffusion electrode and the electrochemical reaction apparatus are joined together by means of clamping, riveting or screwing techniques, a resilient seal is placed between the edge of the gas diffusion electrode and the bearing face of the electrochemical reaction apparatus, to prevent mixing of gas phase and liquid phase.

### Example 10

Fabrication of a gas diffusion electrode of single-layer design: The design is similar to that of Example 9, except that an additional, noncatalyzed gas diffusion layer is applied:

The side which is scheduled for subsequent coating is silvered electrolessly. In order to apply the activation and the gas diffusion layer, the unslotted edge zone is masked on both sides by means of a suitable material such as e.g. wax, paint, adhesive tape or the like. The electrode structure is then covered on the unsilvered side with a gas diffusion layer which beforehand has been rolled out into a sheet and which consists of 70% carbon black (Vulcan XC-72, noncatalyzed), 30% HOSTAFLON TF 2053 (PTFE) with a coverage of 750 g/m², this being bonded to the perforated plate structure by being rolled in, pressure bonded or the like.

The application of the catalyst material-containing coating composition and integration of the electrode into the electrochemical reaction apparatus is effected as in Example 9.

### Example 11

(Electrode Test)

The gas diffusion electrode described in Example 1 was mounted in an electrolytic cell (see FIG. 5) which includes a conventional anode half-cell (18) with a membrane (14). The design of the cathode half-cell differs significantly, however, from the configuration employed in conventional cells—it consists of catholyte gap (15), oxygen-consuming cathode (OCC) (16) and gas space (17).

The catholyte gap (15) has a conventional function; the oxygen reduction, which entails major energy savings compared with the release of hydrogen, takes place at the OCC (16). Located behind the OCC (16) is a gas space (17) which serves for the delivery of oxygen and the discharge of reaction water passing through or of dilute caustic soda solution.

The OCC (16) has a size of 18 cm×18 cm and was operated over a period of 100 days at a stable cell voltage of 1.98 volts; its maximum bending measurement under operating conditions was 0.5 mm.

The following process parameters were set:

current density: 3 kA/m²,

cell temperature: 85° C.,

caustic soda solution concentration: 32 wt %,

brine concentration: 210 g of sodium chloride/l

maximum differential pressure: 24 cm water column

1. Dimensionally stable gas diffusion electrode comprising at least an electroconductive catalyst support material to accommodate a catalyst material-containing coating composition, especially comprising mixtures of finely dispersed silver powder or finely dispersed silver oxide powder or mixtures of silver powder and silver oxide powder and Teflon powder or of mixtures of finely dispersed silver powder or silver oxide powder or mixtures of silver powder and silver oxide powder, carbon powder and Teflon powder, and further comprising an electrical connection, characterized in that the catalyst support material is a fabric, bonded fibre web, foam, sintered metal body or felt of electroconductive material, an expanded-metal plate or a metal plate provided with a multiplicity of perforations on top of which plate the catalyst material-containing coating composition is applied, the material having adequate flexural strength so that additional stiffening by using an additional baseplate can be dispensed with, or the said material being permanently joined mechanically and electroconductively to a gas-permeable, stiff metallic baseplate or a stiff fabric or expanded metal, especially comprising nickel or its alloys or alkali-resistant metal alloys.

2. Gas diffusion electrode according to claim 1, characterized in that the metal for the baseplate is selected from the series consisting of nickel or an alkali-resistant nickel alloy, especially nickel with silver, or silver-coated nickel, or an alkali-resistant metal alloy.

3. Gas diffusion electrode according to claim 1 or 2, characterized in that the catalyst support material comprises carbon, metal, especially nickel or an alkali-resistant nickel alloy, especially nickel with silver or silver-coated nickel or an alkali-resistant metal alloy.

4. Gas diffusion electrode according to any one of claims 1 to 3, characterized in that the baseplate has a multiplicity of perforations, especially slots or drilled holes.

5. Gas diffusion electrode according to any one of claims 1 to 4, characterized in that the baseplate has an imperforate circumferential edge of at least 5 mm.

6. Gas diffusion electrode according to any one of claims 1 to 5, characterized in that the catalyst support material used is a foam or sintered metal body and the edge designated for bonding the electrode to an electrochemical reaction apparatus is compressed.

7. Gas diffusion electrode according to any one of claims 1 to 6, characterized in that the catalyst support material and the catalyst material-containing coating composition are bonded together by dry calendering.

8. Gas diffusion electrode according to any one of claims 1 to 7, characterized in that a coating composition which contains water and possibly an organic solvent, preferably an alcohol and which also contains catalyst material is applied to the catalyst support material by being poured thereonto or wet-rolled and is bonded to the catalyst support material by subsequent drying, sintering and possible compaction.

9. Gas diffusion electrode according to any one of claims 1 to 8, characterized in that between the baseplate and the catalyst support material an additional electroconductive gas distribution fabric is provided which, in particular, comprises carbon, metal, nickel, an alkali-resistant alloy, especially nickel with silver, or silver-coated nickel or an alkali-resistant metal alloy.

10. Gas diffusion electrode according to any one of claims 1 to 9, characterized in that the baseplate has a raised edge region to accommodate the gas distribution fabric.

11. Gas diffusion electrode according to any one of claims 1 to 10, characterized in that the layer of catalyst support material and catalyst material-containing coating composition is bonded circumferentially and gas tightly in the edge region within the electrode to the edge of the baseplate.

12. Gas diffusion electrode according to claim 11, characterized in that the gas tightness in the edge region is achieved by sealing, straight flat-rolling or ultrasonically enhanced flat-rolling.

13. Gas diffusion electrode according to any one of claims 1 to 12, characterized in that the catalyst support material or baseplate used is an open-pore structure, especially a foam, fabric, bonded fibre web or a sintered structure and that the edge region thereof is compressed to achieve gas tightness.

14. Gas diffusion electrode according to any one of claims 1 to 13, characterized in that the gas diffusion electrode has an edge without perforations and at the said imperforate edge is joined gas tightly and electroconductively to an electrochemical reaction apparatus by means of welding, soldering, screwing, riveting, clamping or the use of alkali-resistant, electroconductive adhesive.

15. Gas diffusion electrode according to claim 14, characterized in that the said bonding of the gas diffusion electrode to the electrochemical reaction apparatus is effected by means of welding or soldering, the imperforate edge being silver-free.

16. Gas diffusion electrode according to claim 14, characterized in that the said joining of the gas diffusion electrode to the electrochemical reaction apparatus is effected by means of screwing, riveting, clamping or the use of electroconductive adhesive, the imperforate edge containing silver.

17. Gas diffusion electrode according to any one of claims 14 to 16, characterized in that in the case of a gas diffusion electrode being integrated into the electrochemical reaction apparatus, the edge zone of the baseplate is sealed against the mounting face of the electrochemical apparatus by means of a resilient lining.

18. Method of fabricating a gas diffusion electrode according to claim 1 by sinter-bonding the catalyst support material to a baseplate which is provided with a multiplicity of perforations, and applying the powdered or fibrous catalyst material, which may have been rolled out into a sheet in a separate operation, by dry calendering at a pressure of at least 3·10⁵ pascal.

19. Method of fabricating a gas diffusion electrode according to claim 1 by applying a low-viscosity to paste-like mixture of catalyst material-containing coating composition with water and possibly an organic solvent, for example alcohol, having a solvent fraction of between 0 and 100% and a solids content of between 5 and 95%, to a catalyst support material, the mixture being applied by rolling, spatulation or pouring, followed by drying and sintering at a higher temperature, especially of at least 100° C. and of at most 400° C., under a protective gas, especially nitrogen, carbon dioxide, noble gas or a reducing medium, particularly preferably argon, neon, krypton, butane, and possible further rolling of the sintered composite at a pressure of at least 3·10⁵ Pascal.

20. Method according to claim 18 or 19, characterized in that sinter-bonding of the catalyst support material to a baseplate is followed by the surface of the catalyst support material being provided with a silver layer, especially by electrode deposition or electroless deposition.

21. Method according to any one of claims 18 to 20, characterized in that application of the catalyst support material to a baseplate is preceded by a gas distribution fabric being applied and being sinter-bonded to the baseplate.

22. Method according to claim 21, characterized in that sinter-bonding of catalyst support material, gas distributor and baseplate is effected simultaneously.

23. Electrochemical gas diffusion cell which includes a gas diffusion electrode according to any one of claims 1 to 17.
